(19) United States
(12) Patent Application Publication
(10) Pub. No.: US 2009/0071558 A1
(43) Pub. Date: Mar. 19, 2009

(54) ROTARY CERAMIC CHIP OF A WATER CONTROL CERAMIC VALVE

(76) Inventor: Shao Pin PENG, Tanzih Township (TW)

Correspondence Address: EGBERT LAW OFFICES, 412 MAIN STREET, 7TH FLOOR, HOUSTON, TX, 77002, US

(21) Appl. No.: 11/855,060

(22) Filed: Sep. 13, 2007

(51) Int. Cl. F16K 11/074

(52) U.S. Cl. 137/607; 137/606; 137/625.21

(57) ABSTRACT

The present invention provides an improved rotary ceramic chip of a water control ceramic valve, which is used to address a typical problem, namely, the rising temperature of water control ceramic valve elements. A bypass slot is laterally placed onto the first slot portion of a through-flow slot of the rotary ceramic chip for a water control ceramic valve. When the second slot portion is linked to a hot water inlet of the fixed ceramic chip, the bypass slot is connected to cold water inlet of the fixed ceramic chip. Cold water of predefined flow is guided into through-flow slot to reduce slightly the temperature of hot water, thereby protecting components of the water control ceramic valve and extending the service life of the valve.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a water control ceramic valve, and more particularly to an innovative valve with a through-flow slot in the rotary ceramic chip.

2. Description of Related Art Including Information Disclosed Under 37 CFR 1.97 and 37 CFR 1.98.

The water control ceramic valve is primarily provided with a rotary ceramic chip and fixed ceramic chip. The rotary ceramic chip overlaps the fixed ceramic chip and can be shifted or rotated by the brake valve lever. So, a through-flow slot at a bottom of the rotary ceramic chip aligns with the water inlet and outlet of the fixed ceramic chip, thus controlling the switching of water flow and adjustment of water temperature.

The present invention is intended to improve the through-flow slot structure of said rotary ceramic chip. If a through-flow slot of a typical rotary ceramic chip is linked simultaneously with a hot water inlet and water outlet of fixed ceramic chip, only hot water is supplied. The water outlet is misaligned with cold water inlet.

However, there are shortcomings observed during actual applications. In general, users often adjust the cold water supply mode or cold/hot water supply mode when operating dual-temperature faucets. In such a case, the through-flow slot of the rotary ceramic chip is simultaneously linked with cold and hot water inlets of the fixed ceramic chip, so the overall valve core temperature is moderate. If the hot water supply mode is selected, the rotary and fixed ceramic chips will lead to rising the temperature of the water control ceramic valve due to conduction of hot water. The adverse impact on components will be aggravated gradually. The plastic materials around the rotary and fixed ceramic chips cannot withstand high temperatures for a long period of time, thus leading to rapid degradation of components and shorter service life.

Thus, to overcome the aforementioned problems of the prior art, it would be an advancement in the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The enhanced efficacy of the present invention is as follows:

A bypass slot 12 is laterally placed onto the first slot portion 111 of through-flow slot 11 of rotary ceramic chip 10. When the second slot portion 112 is linked to a hot water inlet of fixed ceramic chip 30, the bypass slot 12 is connected to cold water inlet 32 of the fixed ceramic chip 30. Thus, cold water of predefined flow is guided into through-flow slot 11. If only the hot water supply mode is available for rotary ceramic chip 10, a proper amount of cold water could be guided into through-flow slot 11 of rotary ceramic chip 10 via bypass slot 12, so the temperature of hot water flossing the valve may be reduced slightly, thus protecting the heat-liable components of water control ceramic valve and extending the service life.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an exploded perspective view of a rotary ceramic chip and water control ceramic valve of the present invention.

FIG. 2 shows a schematic view of a rotary ceramic chip of the present invention.

FIG. 3 shows a vertical sectional view of a rotary ceramic chip of the present invention.

FIG. 4 shows an assembled sectional view of rotary ceramic chip and water control ceramic valve of the present invention.

FIG. 5 shows a schematic view of the operation of a rotary ceramic chip of the present invention.

FIG. 6 shows another schematic view of the operation of the rotary ceramic chip of the present invention.

### DETAILED DESCRIPTION OF THE INVENTION

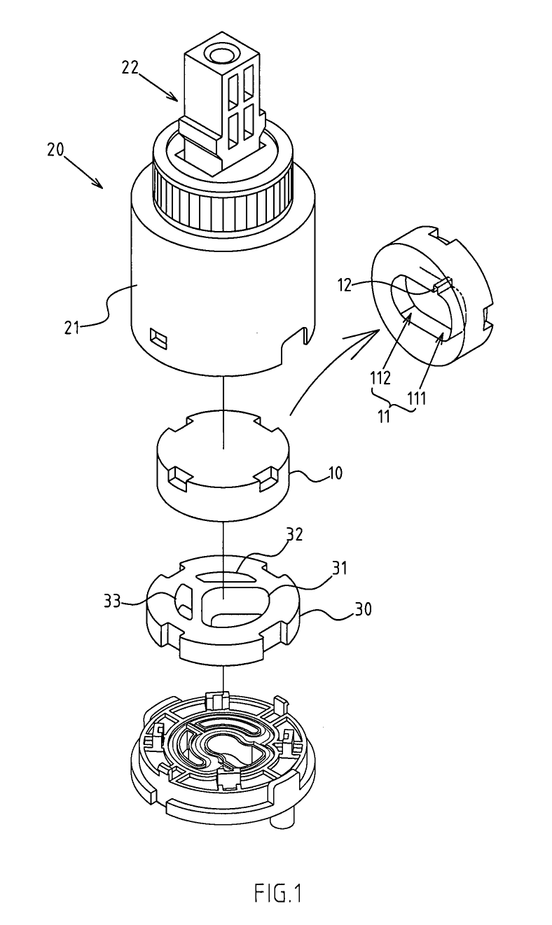

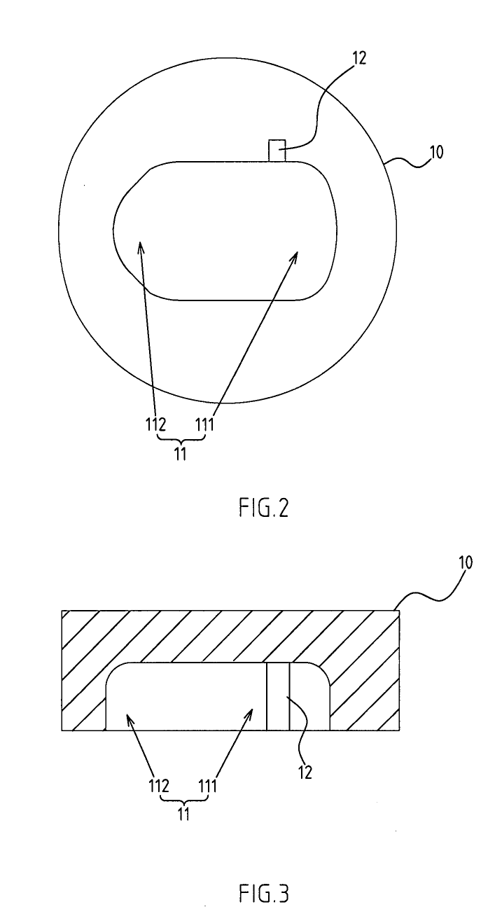

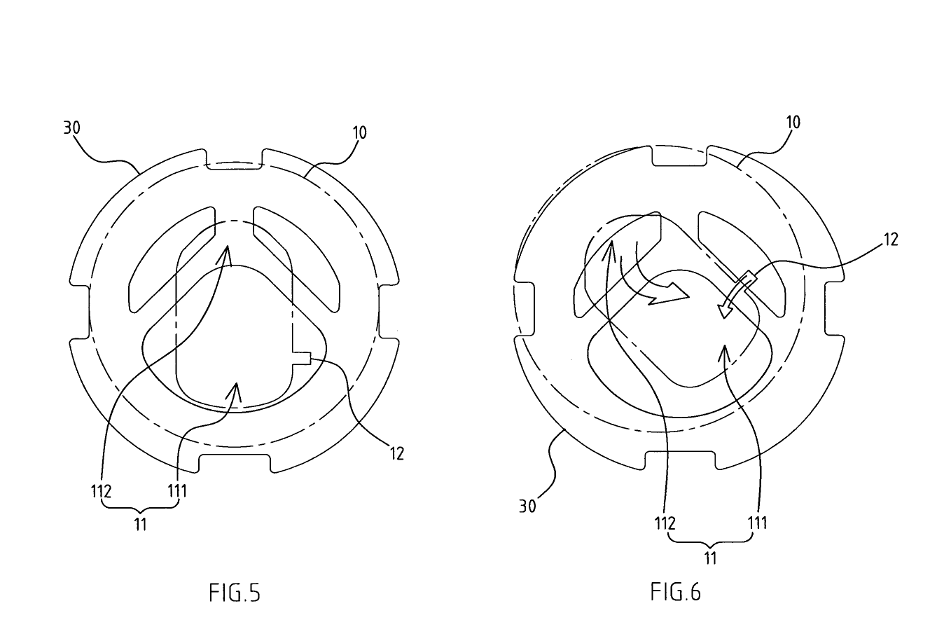

FIGS. 1-6 depict preferred embodiments of improved rotary ceramic chip (2) of water control ceramic valve of the present invention. The embodiments are provided only for explanatory purposes. The scope of the invention is set by the patent claims.

Said rotary ceramic chip 10 is assembled between braking element 22 and fixed ceramic chip 30 within the housing 21 of water control ceramic valve 20. At the bottom of the rotary ceramic chip 10, there is an upward recessing through-flow slot 11. The first slot 111 of the through-flow slot 11 is linked to the water outlet 31 of fixed ceramic chip 30, and the second slot 112 of the through-flow slot 11 linked to cold/hot water inlets 32, 33 of the fixed ceramic chip 30.

Moreover, at least a bleed groove 12 is placed laterally onto the first slot portion 111 of through-flow slot 11. When the second slot portion 112 is linked to hot water inlet 33 of the fixed ceramic chip 30, the bypass slot 12 is also connected to cold water inlet 32 of the fixed ceramic chip 30, so cold water of predefined flow is guided into through-flow slot 11. Said bypass slot 12 is formed in rectangular, pyramidal and semi-circular cross sections.

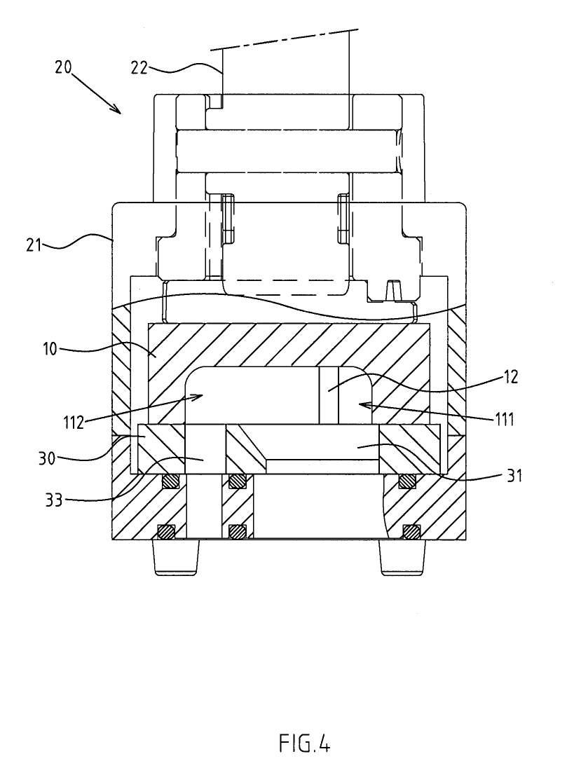

Based upon above-specified structures, the present invention operates as follows. Referring to FIGS. 4, 5 and 6, the internal components of water control ceramic valve 20 are driven by the braking element 22, so that the rotary ceramic chip 10 shifts towards hot water inlet 33 of the fixed ceramic chip 30, and hot water is discharged normally via through-flow slot 11 from water outlet 31 of the fixed ceramic chip 30. In such a case, a proper amount of cold water could be guided into through-flow slot 11 via bypass slot 12 of first slot portion 111 from cold water inlet 32 of the fixed ceramic chip 30, so the mixture of cold and hot water could reduce the adverse impact of rising temperatures on some heat-liable components.

1. A improved rotary ceramic chip of a water control ceramic valve, being assembled between a braking element and a fixed ceramic chip within a housing of said water control ceramic valve, said rotary ceramic chip comprising:
an upward recessing through-flow slot at a bottom thereof, the slot having a first slot portion linked to a water outlet of said fixed ceramic chip and a second slot portion linked to cold/hot water inlets of said fixed ceramic chip; and
a bypass slot placed laterally onto said first slot portion, said second slot portion being linked to a hot water inlet of said fixed ceramic chip, said bypass slot being connected to a cold water inlet of said fixed ceramic chip, cold water of predefined flow being guided into the through-flow slot.

2. The chip defined in claim 1, wherein said bypass slot is formed by rectangular, pyramidal and semi-circular cross sections.
